(19) United States
(12) Patent Application Publication
(10) Pub. No.: US 2010/0206990 A1
(43) Pub. Date: Aug. 19, 2010

(54) System And Method For Icemaker And Aircraft Wing With Combined Electromechanical And Electrothermal Pulse Deicing

(75) Inventor: Victor F. Petrenko, Lebanon, NH (US)

Correspondence Address: LATHROP & GAGE LLP, 4845 PEARL EAST CIRCLE, SUITE 201, BOULDER, CO, 80301, US

(73) Assignee: The Trustees of Dartmouth College

(21) Appl. No.: 12/704,931

(22) Filed: Feb. 12, 2010

Related U.S. Application Data
(60) Provisional application No. 61/152,621, filed on Feb. 13, 2009.

(51) Int. Cl. B64D 15/12; H05B 1/02; F25C 5/08; F25B 1/00; F03D 11/00

(52) U.S. Cl. 244/134 D; 219/490; 62/351; 62/331; 416/95

(57) ABSTRACT

An apparatus for ice removal from a surface has an electrically resistive layer on the surface. An actuation device is provided for mechanically disturbing the surface, as for example deflecting, deforming, or vibrating the surface. When ice has accumulated, an interface layer of ice is melted by heating the electrically resistive layer with an electric current, and an electric current is applied to the actuation device to disturb the surface and release the ice. Alternative embodiments having various forms of actuation device are disclosed. An icemaker using the ice removal apparatus for ice release is described.

### RELATED APPLICATIONS

The present application claims priority from U.S. Provisional Patent Application 61/152,621 filed Feb. 13, 2009, which is incorporated herein by reference.

### FIELD

The present device relates to the field of ice removal from surfaces such as aircraft wings and icemaker ice-forming surfaces.

### BACKGROUND

Ice often forms naturally on some surfaces such as aircraft wings, propellers, and wind-turbine blades, as well as ports for aircraft instrumentation. It is often desirable to remove such ice because the ice not only adds weight to the surfaces, but distorts airfoil shapes and may trigger phenomena such as an unexpected aerodynamic stall. Further, ice often has a rough surface and can contribute significant drag to an aircraft, also degrading aircraft performance. Ice adherent to aircraft wings and fuselage has often been blamed for aircraft accidents. Ice may also obstruct instrumentation. Ice adherent to, and obstructing, aircraft instrumentation has been blamed for such incidents as an Air Florida crash into a bridge over the Potomac.

Ice also forms artificially on other surfaces, such as ice molds for ice makers. Once formed, such ice must be released from the surface, such as an ice mold, so that the formed ice can be transferred to a holding bin.

Prior ice-removal techniques include electromagnetic ice removal such as that described in U.S. Pat. Nos. 3,549,964 and 3,809,341 to Leven, et al.; and U.S. Pat. No. 5,143,325 to Zieve, et al. In these systems, for example in Zieve's FIG. 3B, ice forms on a surface of a conductive metal sheet, or on a surface of a dielectric coating on a conductive metal sheet. Beneath the conductive metal sheet is a flat coil. A brief, high-intensity, electrical current is passed through the coil, causing a first magnetic field to form. The magnetic field induces an electrical current in the conductive metal sheet, thereby forming a second magnetic field. The first and second magnetic fields interact, causing a deflection in the conductive metal sheet. When sufficiently strong deflections are produced in the metal sheet, ice may be detached from the surface.

Ice may stick tightly to surfaces. Systems such as those described in Levin and Zieve may therefore require vigorous deflection to detach ice from the surface. Vigorous, repeated, deflections can cause damage to the conductive metal sheet and dielectric coating (if present) through metal fatigue and similar processes. Further, considerable electric power may be required to dislodge large quantities of ice from large surfaces.

Another ice-removal technique involves heating of the surface to melt a boundary layer of ice adjacent to the surface. Once a boundary layer of ice is melted, adhesion of the ice to the surface is reduced and the ice is typically allowed to slide off of the surface, typically by gravity. As an example, U.S. Pat. No. 6,870,139 to Victor Petrenko describes rapid, “pulse”, heating of surfaces to melt an interface layer to detach ice.

A variety of techniques have been used to heat surfaces for ice removal. In aircraft, heated air tapped from the compressor stage of turbojet and turbofan engines is often ducted along wing edges. In icemakers, refrigerant flow may be reversed after ice has formed; the reversed refrigerant flow heats the ice mold to melt a layer of ice and release the ice from the mold. Electric currents, as describe in U.S. Pat. No. 6,870,139, have also been applied to heat surfaces to release the ice. For example, icemakers have been proposed that use resistive electric heating to release ice from their icemaking surfaces and/or ice molds.

Heating surfaces to remove ice may require considerable power, and often results in the released ice being coated with a layer of melt water. In some icemaking systems, this layer of melt water can result in ice cubes or other ice bodies sticking to each other as the melt water refreezes. Improved energy efficiency and reduced ice body sticking can result from reducing thickness of the melted boundary layer thereby allowing melted interface water to refreeze quickly.

The system of Giamati, U.S. Pat. No. 6,129,314 combines electromagnetic and electrothermal deicing technologies on, for example, an aircraft wing. The system of Giamati, in column 8 lines 44-54, provides electrical heating on the leading edge of the wing, with no electrical heating on areas behind the leading edge—where meltwater from the leading edge is allowed to refreeze. Giamati uses only electromagnetic ice removal behind the leading edge. The electrothermal heating of Giamati “heats the skin continuously once an icing condition is encountered” (cols. 9, 52-53) such that the ice melts, meltwater flows to the rear, refreezes, and then may be expelled by the electromagnetic subsystem. Giamati uses thermostatic temperature regulation to maintain leading edge skin temperature at a desired level.

Giamati discusses deflections of twenty to sixty thousandths of an inch, at frequencies of 2 kHz, producing peak accelerations in the skin of three thousand gravities in the unheated areas behind the leading edge; Giamati also discusses use of materials such as titanium, with high elastic modulus and little damping, for the deiced surfaces.

### SUMMARY

In a first exemplary embodiment thereof, an inventive apparatus for removing ice from a surface has an electrically resistive layer of the surface. An actuation device is provided for deflecting or otherwise causing a deformation in, the surface. When ice has accumulated on the surface, an interface layer of ice is rapidly melted by heating the electrically resistive layer with a pulse of an electric current, and an electric current is applied to the actuation device to deflect or otherwise deform the surface, and to thereby release the ice from the surface. Alternative embodiments having various forms of actuation device are disclosed. An exemplary embodiment of an icemaker using the inventive ice removal apparatus to achieve rapid ice release after formation thereof, is also described.

In another embodiment thereof, the inventive apparatus for removing ice from a surface includes an electrically resistive layer positioned on or proximal to the surface, and an actuation device apparatus coupled thereto, that is selectively operable to deflect or otherwise deform the surface upon receiving electric power. The inventive apparatus also includes a power supply and control device operable to selectively provide power to the resistive layer, thereby heating the resistive layer to rapidly melt a thin interfacial layer of ice, and to provide power to the actuation apparatus to enable it to cause sufficient deformation in the surface to detach the ice before the melted ice layer refreezes. In one specific embodiment, the actuation device is an electromagnet with the surface having a magnetic layer attached, in another specific embodiment the actuation device is a solenoid coupled to deflect the surface, in another specific embodiment the actuation device is a conductive layer of surface that positioned to interact inductively with magnetic fields from a coil.

Another embodiment has a surface with a resistive layer, and a dielectric layer, and a coil attached to the dielectric layer of the surface and disposed adjacent to a conductive sheet attached to a support. In this embodiment a power supply is coupled to provide power to the resistive layer, and to the coil. During a deice cycle, the power supply apparatus provides an electrothermal pulse to the resistive layer and an actuation pulse to the coil; the actuation pulse to the coil inducing a current in the conductive sheet to produce a force between sheet and coil. The pulses are timed such that the pulse to the resistive layer results in a peak melting at the time that the pulse to the coil results in a maximum mechanical force separating the ice from the surface. The resistive layer has at least a portion overlying the coil.

Another embodiment has an apparatus for removing ice from a surface, the surface having a resistive layer, with a first coil attached to the dielectric layer, and a second coil attached adjacent to the first coil and attached to a support. A power supply provides power to the resistive layer to melt an interfacial layer of ice thereby loosening the ice, and then to the first and second coils, to deflect the surface to release the ice.

An icemaker has an ice-forming surface having a resistive layer formed on a dielectric layer and a cold plate disposed to remove heat from the ice-forming surface such that water on the ice-forming surface solidifies into ice. An actuation device deflects the surface upon application of electric power to the actuation device, and water dispensing apparatus is provided for applying water to the ice-forming surface. A power supply provides a pulse of power to the resistive layer to melt an interface layer of ice, and a pulse of power to the actuation device to deflect or deform the ice-forming surface and eject the ice.

An alternative embodiment of the icemaker has an ice-forming surface on a micro-channel cold-plate, the cold plate being chilled to remove heat from water on the ice-forming surface such that the water solidifies into ice. The surface has a resistive layer formed on a dielectric layer. An actuation device deflects the cold plate upon application of electric power to the actuation device, and water dispensing apparatus is provided for applying water to the ice-forming surface. A power supply provides a pulse of power to the resistive layer to melt an interfacial layer of ice, and a pulse of power to the actuation device to deflect or deform the ice-forming surface and eject the ice when ice release is desired.

A wing or a windmill blade has a surface sheet; a dielectric layer applied over the surface sheet; a resistive layer applied over the surface sheet; an actuation device disposed to deflect or deform the surface sheet; and a power supply and controller apparatus. The power supply and controller apparatus is coupled to provide an electrothermal pulse to the resistive layer, and an electromagnetic pulse to the first coil in a deice cycle.

### BRIEF DESCRIPTION OF THE DRAWINGS

FIG. 1A is schematic cross section of a surface with ice adherent, and equipped with an ice removal system.

FIG. 1B is a schematic cross section of a central portion of an embodiment of the surface of FIG. 1A.

FIG. 1C is schematic cross section of a surface with ice adherent, and equipped with an alternative ice removal system.

FIG. 1D is a schematic cross section of an alternative embodiment of a surface with ice adherent and equipped with another alternative ice removal system.

FIG. 1E is a schematic cross section of an alternative embodiment of a surface with ice adherent, and equipped with an ice removal system.

FIG. 2A is a flowchart of a method of ice removal adapted for use with the ice removal system of FIG. 1.

FIG. 2B is a schematic cross section of an alternative embodiment of a surface with ice adherent and equipped with another alternative ice removal system.

FIG. 2C is a schematic cross section of an alternative embodiment of a surface with ice adherent and equipped with another alternative ice removal system.

FIG. 2D is a schematic cross section of an alternative embodiment of a surface with ice adherent and equipped with another alternative ice removal system.

FIG. 3 is a schematic cross section of a surface with ice adherent, and equipped with a dual-coil ice removal system.

FIG. 4 is a cross sectional view of a surface with ice being detached by the system of FIG. 3, having an additional dielectric layer for safety, and showing meltwater from the interfacial layer.

FIG. 5 is a schematic view of an ice-flake maker embodying the ice removal system of the present invention.

FIG. 6 is a schematic view of an alternative ice-flake maker embodying the ice removal system.

FIG. 7 illustrates pulses applied for an embodiment similar to that of FIG. 1.

FIG. 8 is an example of a cross section of a cold plate and ice of an icemaker resembling the embodiment of FIG. 6 with thick dielectric layer portions for scoring ice.

FIG. 9 is a schematic diagram of an embodiment performing electrothermal and electromagnetic ice separation in a coil layer.

FIG. 9A is a schematic diagram of an alternative embodiment wherein electrothermal and electromagnetic ice separation is performed in a coil.

FIG. 9A is a schematic diagram of an alternative embodiment wherein electrothermal and electromagnetic ice separations are performed in a coil.

FIG. 9B is a schematic diagram of an alternative embodiment wherein electrothermal and electromagnetic ice separation are performed in a coil.

FIG. 9C is a schematic diagram of an alternative embodiment wherein electrothermal and electromagnetic ice separation are performed in a coil.

FIG. 10 is a cross section of an icemaker having an ice-forming surface embodying the electrical schematic of FIG. 9.

FIG. 11 is a cross section of an aircraft wing or windmill blade fitted with the deicing system.

FIG. 12 is a plan view of an aircraft wing or windmill blade fitted with the deicing system.

### DETAILED DESCRIPTION OF THE EMBODIMENTS

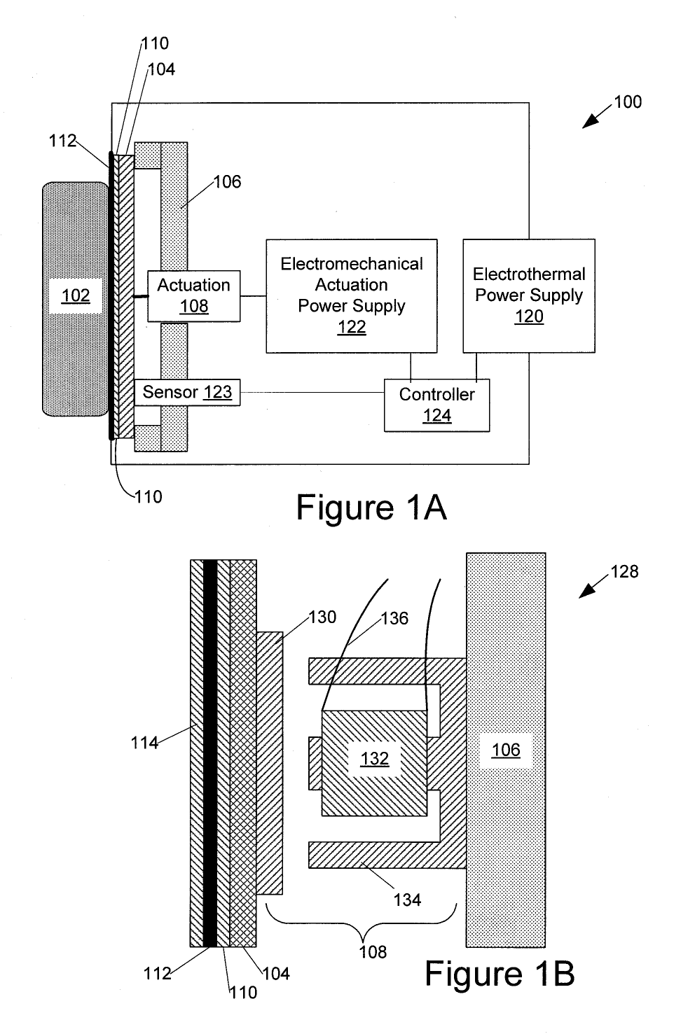

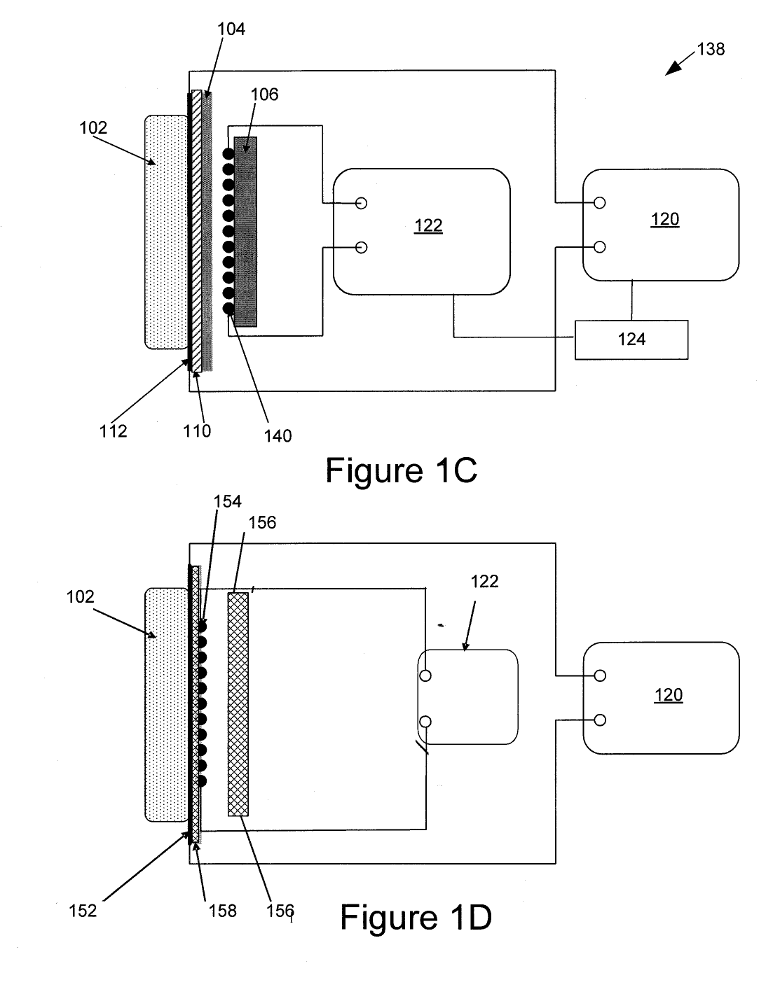

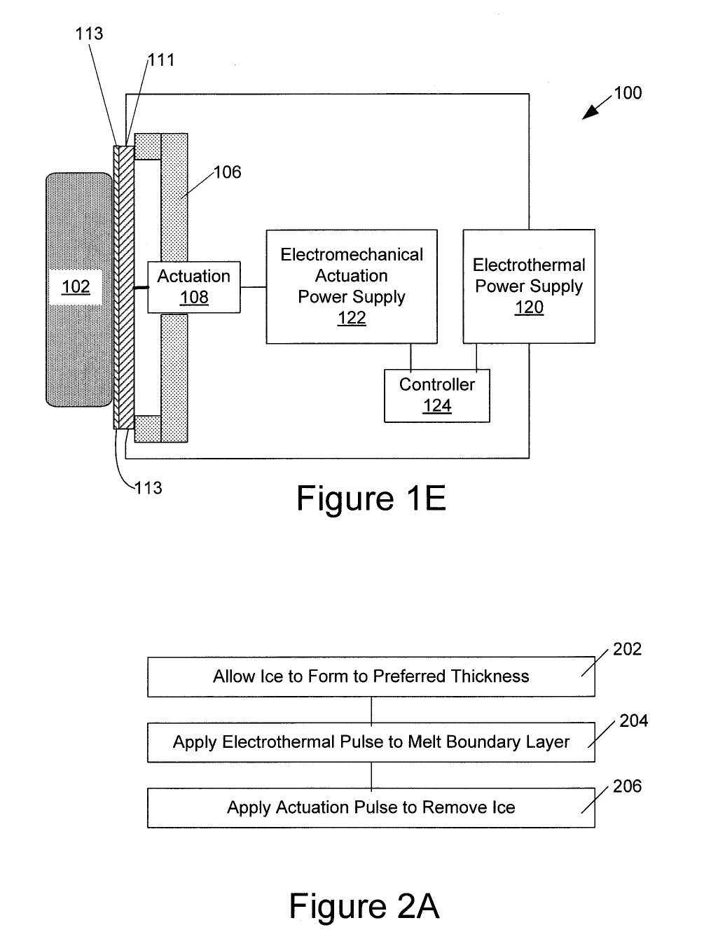

A system 100 for ice 102 removal from a surface sheet 104 of an object is illustrated in FIG. 1A.

In this system 100, a surface sheet 104 of object to be deiced is attached to structural members 106 and coupled magnetically and/or physically to an electromechanical actuation device 108. Electromechanical actuation device 108 may be an actuator operable though generation of one or more electromagnetic forces such as voice coils, electric motors, and electromagnetic induction coils and hereinafter referred to as an electromagnetic actuation device; electromechanical actuation device 108 may also be a piezoelectric or a magnetostrictive actuator coupled to, or positioned in sufficient proximity and alignment to the surface sheet 104 to selectively cause, upon activation thereof, a mechanical disturbance in the surface sheet 104 of a desirable predetermined type and magnitude. The type(s) of mechanical disturbance caused by the actuation device 108, may include, but is not limited to, at least one of: deformation, vibration, deflection, oscillation, and equivalents thereof.

Surface sheet 104 in an embodiment is a metal or polymer sheet having a degree of flexibility and elasticity, such as a thin sheet of steel, a sheet of an elastomer, a sheet of aircraft aluminum or a sheet of aircraft titanium, that will flex if deflected but will tend to return to an original shape or position upon removal of any deflecting forces. Surface sheet 104 in an embodiment is a skin of an aircraft wing, fuselage, or nacelle; in an alternative embodiment surface sheet 104 is an ice-forming surface of an icemaker machine, or an evaporator of a refrigeration system, or a building roof.

The surface sheet 104 in an embodiment is preferably coated with a layer of an insulator 110, also known herein as a dielectric coating, the insulator typically being a layer of polymer. In embodiments where surface sheet 104 is aluminum or titanium, insulator 110 may be an anodized oxide layer. In alternative embodiments insulator 110 may be a layer of a deposited oxide such as silicon dioxide, or other electrically insulating oxide, that is amenable to deposition on surface sheet 104. It is desirable that insulator 110 be firmly adherent to surface sheet 104. In an alternative embodiment where surface sheet 104 is a sheet of an electrically insulating polymer, insulator 110 may be omitted.

A resistive layer 112 of an electrically resistive conductor is deposited over insulator 110. The electrically resistive conductor of resistive layer 112 may be stainless steel, nickel-chromium alloy, carbon-filled conductive polymer, molybdenum, a very thin layer of silver or copper, or a layer of other materials known in the art of electrical resistive elements. It is desirable that resistive layer 112 be firmly adherent to insulator layer 110.

In some embodiments, a surface electrically-insulating layer 114 (FIG. 1B) is deposited over resistive layer 112. In embodiments having insulating layer 114, it is desirable that it be firmly adherent to resistive layer 112. Second insulating layer 114 is typically a layer of polymer, however in alternative embodiments, insulator 114 may be a layer of a deposited oxide, such as silicon dioxide or other electrically insulating oxide that is amenable to chemical vapor deposition on resistive layer 112. Surface insulating layer 114 prevents undue corrosion due to current flow through melt water as well as enhancing safety by avoiding current flow through people or animals that may touch the surface.

In the structure of the surface to be deiced of the embodiments discussed with reference to FIG. 1A, surface sheet 104 provides the mechanical strength and resilience of the surface to be deiced, insulator 110 provides electrical insulation between conductive surface sheets 104 and the resistive layer 112. Resistive layer 112 forms an electric resistive heater, and surface insulating layer 114 serves as a protective coating and safety feature.

The surface to be deiced may have additional layers not illustrated to enhance adhesion between layers, or for other purposes.

The system may have additional safety features in addition to insulating layer 114. For example, aircraft wing deice systems may be equipped with a “squat switch” to prevent operation of the system on the ground, or an engine interlock switch to prevent operation of the system when the engines are not operating to protect ground crew from accidental contact with electrified surfaces. When surface sheet 104 forms a component of an icemaker, as described below, a safety interlock switch may prevent operation of the system with access panels, doors, or covers are open to prevent contact between operating personnel and electrified surfaces. Similarly, baffles may be provided in discharge chutes to prevent curious fingers from reaching electrified surfaces.

A pulse-electrothermal power supply 120 is electrically coupled to the resistive layer 112 for providing an electrical current to the resistive layer to heat the resistive layer. Similarly, an actuator power supply 122 is electrically coupled to the actuation device 108 to provide sufficient electrical power to drive actuation device 108 to displace surface sheet 104. Pulse-electrothermal power supply 120 and actuator power supply 122 operate under control of a controller 124 which properly sequences and times their operation.

In the alternative embodiment of FIG. 1E, surface sheet 111 serves both to provide the mechanical strength and resilience of the surface to be deiced, and as an electrical resistive heating layer similar to the resistive layer 112 of FIG. 1A. In this embodiment, surface sheet 111 is fabricated from a material having both significant electrical resistance and strength, such as a nickel-chromium alloy. In this embodiment, insulator layer 113 is provided to serve as a protective layer and safety insulation layer. The power supplies 120, 122, controller 124, structural members 106 actuation device 108, and ice 102 of this embodiment are as previously discussed with reference to FIG. 1A.

In a particular embodiment 128, as illustrated in FIG. 1B, the actuation device 108 has a magnetic sheet 130 of a ferromagnetic material such as carbon steel or iron attached to surface sheet 104. Close to magnetic sheet 130 is a coil winding 132 wound on a core 134 of ferromagnetic material such as laminated iron, ferrite, or powdered iron in a binder; in an embodiment core 134 has an E shape with a central rod, in an alternative embodiment core 134 is a pot core having a cup with a central rod such that a cross section of core 134 taken through the central rod has an E shape. Core 134 is firmly attached to a structure member of structure members 106, core 134 and coil 132 also form part of actuation device 108. In this embodiment, an electric current applied through leads 136 to coil 132 causes an intense magnetic field to form between the center rod of core 134, magnetic sheet 130, and remaining portions of core 134 thereby attracting magnetic sheet 130 to core 134 and mechanically disturbing surface sheet 104 by displacing surface sheet 104 towards core 134; the combination of coil 132 and core 134 can be described as an electromagnet. In an alternative embodiment wherein surface sheet 104 is made of a ferromagnetic material, magnetic sheet 130 is omitted, and surface sheet 104 takes on the function of magnetic sheet 130 as described above.

In an alternative embodiment 138, as illustrated in FIG. 1C, actuation device 108 has a coil 140 attached to a structural support 106. In this embodiment, surface sheet 104 is a conductive metal sheet, such as a sheet of aircraft aluminum, lying over coil 140. Surface sheet 104 has an insulating layer or dielectric coating 110 adherent to it, with an electrically conductive but resistive layer 112 deposited or laminated over the dielectric coating 110. An additional dielectric coating (not shown) may be present over the resistive layer 112.

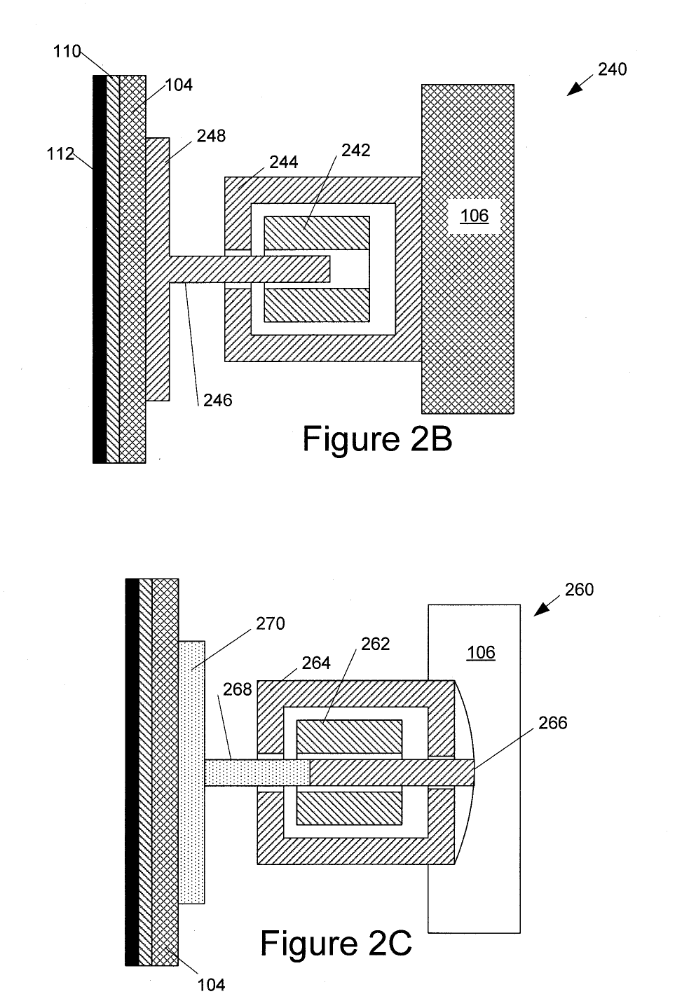

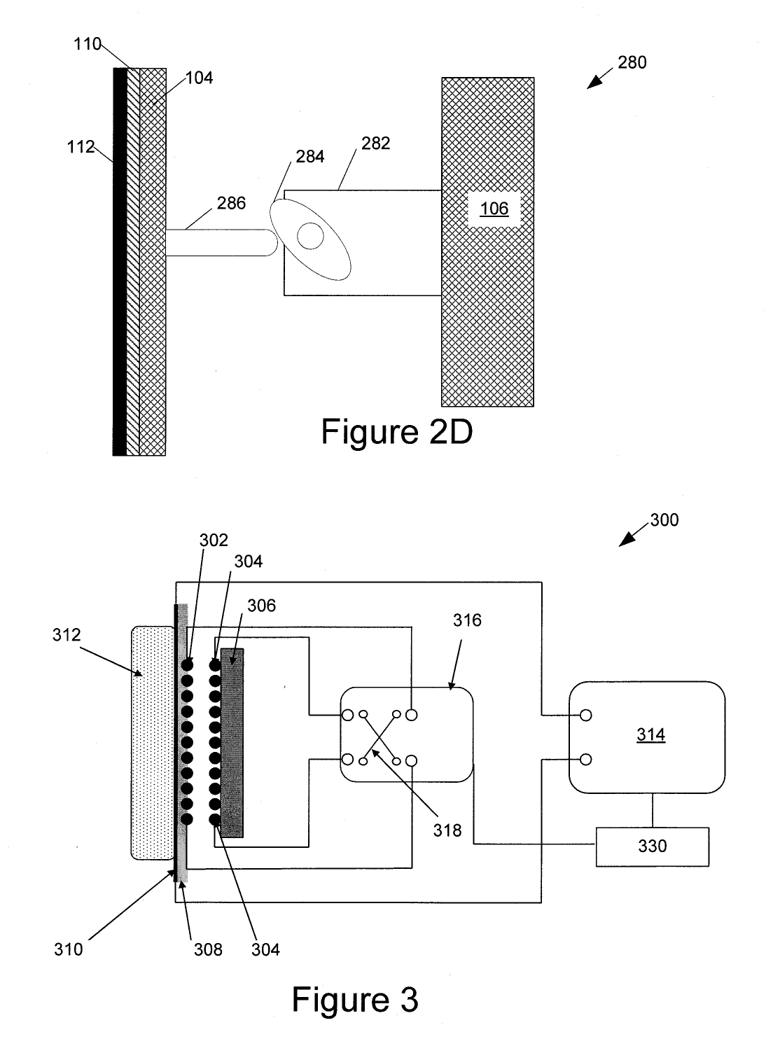

In operation, as illustrated in FIG. 2A with reference to FIGS. 1A-1D, ice 102 is allowed to grow 202 to a desired thickness. Then, a deice cycle begins with a current pulse applied 204 to the resistive layer 112 by pulse electrothermal power supply 120. Pulse electrothermal power supply 120 is, for example, an intermittent-duty power supply capable of applying high power to the resistive layer 112 for a short period of time, but incapable of applying high power to resistive layer 112 continuously; such intermittent-duty power supplies are often much less expensive than continuous-duty power supplies having the same peak power capacity. Resistive layer 112 may comprise stainless steel, nickel-chromium alloy, or carbon-filled conductive polymer as known in the art of electrical resistive elements. Resistive layer 112 may also comprise a serpentine strip of aluminum or copper foil, which in some embodiments may be patterned to provide suitable overall resistance such that current applied by electrothermal power supply 120 will heat resistive layer 112. Resistive layer 112 may be applied as a layer of foil attached to dielectric layer 110 with adhesive, or may be applied by evaporation, sputtering, painting, or other techniques that provide a conductive resistive layer 112 firmly adherent to a dielectric layer 110.

In operation of the embodiments of FIGS. 1A-1E, the current pulse applied to resistive layer 112, or to resistive surface sheet 111, is sufficient to rapidly melt a thin layer of the interfacial ice layer where ice 102 is adherent to resistive layer 112 or an insulating coating over resistive layer 112. Melting of this thin layer softens the adhesion of the ice to the resistive layer—the ice is now held by capillary action of melt water instead of rigid adhesion, and is capable of sliding.

After the pulse applied 204 to the resistive layer 112 by pulse electrothermal power supply 120 begins, and in many embodiments shortly before it ends, a pulse of actuation power is applied 206 by actuation power supply 122 to actuation device 108. In the embodiment of FIG. 1B as described above, actuation pulse current from actuation power supply 122 causes deflection of surface sheet 104 towards core 134. In an embodiment, power supply 122 provides a pulsating or alternating current to coil 132, and surface sheet 104 rebounds between pulses or half-cycles of the current, thereby causing the surface sheet 104 to be mechanically disturbed by rapidly vibrating. In this embodiment, power supply 122 may incorporate a charged capacitor and a switching device, to couple the capacitor in parallel with the coil 132 such that the capacitor resonates with inductance of coil 132 and produces an alternating current in coil 132 when the switching device closes. In an embodiment, the electrothermal pulse has duration of less than one second, and the actuation pulse has a duration of less than about 10 milliseconds. The deice cycle ends on completion of the actuation pulse; and the deice cycle typically has duration of less than ten seconds. In an embodiment, the resonant frequency of coil 132 and the capacitor is in the range from 5 kHz to about 50 kHz; in a particular embodiment the resonant frequency is in the range from 5 kHz to 9 kHz to prevent undesirable radio frequency emissions.

There is thermal inertia in the system, such that melting of the ice-surface boundary layer occurs a finite time after application of the electrothermal pulse. Similarly, there is mechanical inertia in the system, such that maximum acceleration of the surface away from ice (and hence maximum ice-detaching mechanical force) occurs a finite time after application of the electromechanical actuation pulse; in some embodiments (including many embodiments where the actuation device pushes surface away from structure) maximum ice-detaching mechanical force occurs after the actuation pulse ends while components rebound. The preferred timing relationship of electrothermal and electromechanical actuation pulses therefore depends somewhat on the type of actuation device, mechanical and physical properties of the surface and actuation device, and in some embodiments on thickness of the ice. The electrothermal pulse and the actuation pulse are preferably synchronized during each cycle in such a way that the maximum ice-detaching mechanical force is applied to the interface at the point in time when maximum melting of the interface has occurred; in some embodiments this requires the actuation pulse to begin shortly before the electrothermal pulse ends. In an embodiment, the electrothermal pulse has duration of less than one second, and the actuation pulse has a duration of less than about 10 milliseconds.

In some embodiments, a sensor 123 (FIG. 1A) is positioned to monitor presence and thickness of the ice, and to report that thickness to controller 124. In some embodiments where the surface 104 is not subject to many environmental forces, such as an icemaker, sensor 123 may be a load cell at a joint between surface 104 and support 106, the load cell adapted for weighing accumulated ice 102. In other embodiments, sensor 123 may be a piezoelectric ultrasonic sensor that produces, and observes changes in, vibrations as ice accumulates on surface 104. In other embodiments, sensor 123 may be an electro-optical sensor. Measurements from sensor 123 are provided to sequence controller 124 for estimating thickness of the ice.

In an embodiment, controller 124 uses measurements of ice 102 thickness from sensor 123 to activate a fixed duration deice cycle having fixed timing relationships when ice has accumulated to a predetermined threshold depth. This embodiment is particularly useful in an ice-flake maker for providing ice flakes of uniform thickness. In an alternative embodiment, controller 124 uses measurements of ice 102 thickness to determine a desired magnitude of a power pulse to be provided by actuation power supply 122 to actuation device, and a desired timing relationship between an actuation pulse provided by power supply 122 and an electrothermal pulse provided by electrothermal power supply 120. In an embodiment, the desired duration and timing relationship is determined by looking up these values in a table that is indexed by ice thickness.

Once the controller 124 determines that a deice cycle is desired, and that a desired duration and timing relationship of actuation and electrothermal pulses, the controller 124 provides appropriate commands to the electrothermal power supply 120 and actuation power supply 122 to generate those pulses to deice the surface.

Insulating or dielectric layer 110 may comprise one or more electrically insulating solid materials such as metal oxide, plastic polymer, or a composite material. Dielectric layer 110 may be applied to conductive sheet 108 by anodization if, for example, surface sheet 104 has high aluminum or titanium content. Dielectric layer 110 may also be applied by sputtering, by lamination with an adhesive, by painting, or through other methods that produce an electrically insulating layer firmly adherent to surface sheet 104.

In the embodiment 138 of FIG. 1C, conductive surface sheet 104 is typically formed of a metal or metal alloy such as copper, aluminum, silver, or alloys thereof. Surface sheet 104 may also be a laminate having a strength layer of titanium with a conductive layer of aluminum. In this embodiment, conductive surface sheet 104 and coil 140 together form an actuation device 108.

Coil 140 is typically fabricated from a metal conductor such as copper or aluminum. Coil 140 may be formed from wire of circular or rectangular cross section, or from a conductive foil such as a copper laminate as known in the art of printed circuits. The conductor of coil 140 is, for example, wound as a circular, triangular, elliptical, or rectangular spiral of least one layer.

In the embodiment of FIG. 1C, the electrical current from actuation power supply 122 causes a first magnetic field to form in the coil 140. This first magnetic field induces an electrical current in the conductive metal surface sheet 104, thereby forming a second magnetic field. The first and second magnetic fields interact, causing a deflection in the conductive metal sheet 104. When sufficiently strong deflections are produced in the metal surface sheet 104, ice 102 is deflected away from resistive layer 112; in the process ice 102 may crack in some embodiments.

In the embodiment of FIG. 1D, deflections produced in surface sheet 104 by the interacting magnetic fields are repulsive, deflecting the sheet away from coil 140. As the pulse from actuation power supply 122 ends, the sheet returns to its original position relative to the coil 140 because of elasticity in sheet 104. In an alternative embodiment, actuation power supply 122 applies 206 a brief sequence of pulses instead of a single pulse of power, thereby causing metal sheet 104 to vibrate. Since metal sheet 104 is in contact with dielectric layer 110, and dielectric layer 110 is in contact with resistive layer 112, vibrations of metal sheet 104 are transmitted to the interface between ice 102 and resistive layer 112.

In an embodiment of the system of FIG. 1C, the actuation power supply 122 applies 206 current to the coil 140 at high frequency such that skin depth of the eddy current in metal sheet 104 fails to penetrate all the way through sheet 104. For example, in an embodiment, power supply 122 applies 206 current at two kilohertz; a skin depth at this frequency is approximately nine tenths of a millimeter in aluminum. In this embodiment, conductive surface sheet 104 is fabricated from aluminum of between one and two millimeters thick. In this way, little electromagnetic energy from coil 140 reaches resistive layer 112, and loss-prone eddy currents are not produced in the resistive layer.

In both the embodiments of FIGS. 1B and 1C, the electrothermal power supply 120 and actuation power supply 122 operate under control of a deicing sequence or pulse-sequence controller 124. Electrothermal power supply 120 and actuation power supply 122 are sometimes collectively referred to as a power supply apparatus, and in some embodiments, may be combined into a single power-supply and controller package.

In the embodiments of FIGS. 1A-1E, as ice 102 is deflected away from resistive layer 112, air is admitted between ice 102 and resistive layer 112, expanding a space initially occupied by meltwater formed as the boundary layer melted. As air is admitted, the ice 102 then separates from the resistive layer 112.

A primary advantage of the system of FIGS. 1A-1B-1C and the method of FIG. 2 is that by melting a boundary layer of ice 102 by applying 204 power to resistive layer 112 prior to applying 206 power to the actuation device to electromechanically deflect conductive metal sheet 104, much less deflection of metal surface sheet 104 is required than with prior methods of electromagnetic or electromechanical ice removal, thus, decreasing damage to the metal sheet and preventing metal fatigue. A secondary advantage is that less total electrical energy is required than needed for ice separation with a pulse electrothermal method because less interfacial ice need be melted and thinner interfacial layers of ice and substrate are heated by a shortened heating pulses.

The embodiment of FIGS. 1C and 2A may be reversed as shown in FIG. 1D. In the embodiment of FIG. 1D, rigid support 156 is fabricated from a conductive material such as aluminum. Coil 154 is attached to dielectric membrane 158, and resistive layer 152 is firmly laminated to dielectric membrane 158. Application of the electrothermal pulse is as described above with reference to FIGS. 1C and 2A. Application of the actuation pulse by actuation power supply 122 results in coil 154 being repelled from conductive support 156 in the manner previously discussed with reference to conductive surface sheet 104. This deflection moves resistive layer 152, thereby applying mechanical stress to the melted ice 102-resistive layer 152 interface, forcing admission of air beneath the ice, and detaching the ice.

In an embodiment of the ice removal apparatus of FIG. 1C or 1D, coil 140, 154 has radius of twenty-five millimeters and is fabricated of a spiral of copper wire having one millimeter diameter. A conductive surface sheet 104 is made of type 2024 aluminum two hundred millimeters square and one millimeter thick, with edges fixed to a structural support 106. Ice 102 is allowed to accumulate to a thickness of two millimeters before the ice-removal process is executed. Insulating layer 110 is a twenty-five micron thick layer of Kapton insulation, and resistive layer 112 is a twenty-five micron thick layer of stainless steel. An air gap (not shown) of three millimeters is provided between surface sheet 104 and coil 140 to allow for movement of surface sheet 104 when actuation device 108 is active.

An exemplary embodiment of an implementation of the inventive device, shown in FIG. 1C or 1D, has a surface of about twenty by twenty centimeters (0.04 square meters) maintained at a temperature of minus ten C, the electrothermal power supply 120 is a bank of two farads of supercapacitors charged to twenty-five volts storing 625 joules of energy, with an electronic switch for coupling the capacitors to resistive layer 112 for a pulse duration of twenty milliseconds. An average pulse power of ten kilowatts is transformed by resistive layer 112 into heat, with the magnitude of total pulse energy of about two hundred joules in about twenty milliseconds; thereby applying an electrothermal pulse to melt a boundary layer of ice, having a power density of about two hundred fifty kilowatts per square meter. This embodiment of the present invention utilizes about another eleven joules of energy in the actuation pulse to deflect the surface to release ice of two millimeters thickness. Accordingly, this embodiment of the present invention uses approximately 5.275 kilojoules per square meter of total pulse energy, as compared to the energy requirements of a similar device having only electrothermal deicing capabilities, which requires 50 to 100 kilojoules per square meter of total pulse energy to remove ice. Other embodiments may require additional energy, for example removal of thicker ice may require additional energy in the electromagnetic pulse to achieve similar accelerations, deflections, or deformations.

It has been found desirable that electrothermal pulses applied by electrothermal supplies 120, 618, 314, 528-530 to the resistance layers 112 herein described with reference to both the icemaker and deicing devices should be applied in short, high-intensity, pulses to concentrate heat at the boundary between the surfaces of the ice 102, 520 and surface sheet 104, 512 and prevent that heat from dissipating by diffusion through the ice and surface sheet. In various embodiments this power is applied at power densities of at least fifty kilowatts per square meter of boundary area. In some embodiments, power is applied at significantly higher power densities such as up to two megawatts per square meter; a 2 MW/m² pulse for one millisecond applies two thousand joules per square meter of heating energy. The heating-pulse duration is between one millisecond and ten seconds, but is typically between 5 milliseconds and one half second, and generally is shorter when higher power densities are used. Since these deicing power pulses are short and represent a small fraction of icemaker operation, the average power consumption of the deicing device is far below the peak power applied during ice release.

In both pulse electrothermal deicing as previously used, and the combined electrothermal and electromechanical/electromagnetic method herein described, most of the energy required for deicing is used to heat the interface to melt the boundary layer of ice. Because heat diffused from the interface layer into the ice, surface, and other portions of the object being deiced, the minimum energy requirement (for thinnest melted layer and thinnest heating foils) to melt a boundary layer is inversely proportional to a square root of pulse duration or to the density of the heating power. The melted boundary layer, however, tends to refreeze after the end of the electrothermal pulse as heat continues to diffuse from the interface. An advantage of the combined deicing system herein disclosed is that the released ice is more quickly removed from the surface than with pulse electrothermal deicing alone, where additional heating may be required to prevent refreezing while ice is sliding off the surface.

As a result, for most applications the combination deicing systems herein described permits use of heating pulses up to two orders of magnitude shorter than the one or more seconds required by a typical prior pulse electrothermal deicer while using total deicing energy of about one tenth that consumed by the prior pulse electrothermal deicer.

In another embodiment of the device of FIG. 1C or 1D, actuation power supply 122 is a one hundred ten microfarad capacitor charged to four hundred fifty volts with an electronic switch for coupling the capacitor to the coil 140, achieving a pulse duration of one and three fourths milliseconds. The coil and capacitor resonate at 5.6 kHz, producing a damped pulse of alternating current at this frequency, resulting in eleven joules of mechanical energy applied to the surface sheet 104 and a peak force of about three thousand seven hundred Newtons. Maximum deflection of the center of surface sheet 104 in this embodiment is about eight millimeters. This embodiment is deiced with total energy of about 111 joules, significantly less than that required for deicing by pulsed electrothermal deicing alone.

In alternative embodiments, the heating pulse duration ranges from 5 to 50 milliseconds for best efficiency; although some embodiments may involve longer but lower-current power heating pulses. Generally, shorter heating pulses require greater instantaneous power but require less total energy than long pulses because there is less time for heat to diffuse into the ice and components of the system. The electromagnetic actuation pulse of single-coil systems, or the first or pushing phase (where the coils repel each other) of dual-coil systems, typically ranges from one millisecond for thin ice of about one millimeter thickness to twenty milliseconds for use with thicker ice of about two centimeters thickness. The second or pulling phase (where the coils attract each other) of dual-coil systems typically is near one millisecond irrespective of ice thickness. When an alternating current is used in the coil, an appropriate frequency is selected typically in the range from about 1 kHz to about 50 kHz.

Peak tension stress on the ice-surface interface zone typically occurs after the end of the first or pushing phase of the electromagnetic pulse, and during the time that elasticity of the conductive metal plate in single-coil systems, or the second or pulling phase of the electromagnetic pulse in dual-coil systems, is attempting to return the surface from its distorted to its normal position. At this time, the ice has been accelerated away from, and its inertia tends to keep it moving away from, the resistive layer 112, while elastic and/or electromagnetic forces on resistive layer 112 and other components act to pull the resistive layer 112 away from the ice.

Peak melting of the ice-surface interface zone typically occurs at, or shortly after, the electrothermal pulse ends, as heat diffuses from resistive layer 112 into and through the interface zone.

For maximally efficient ice removal, the time of peak tension stress on the ice-surface interface zone should approximately coincide with the time of peak melting of the ice-surface interface zone.

Other configurations of actuation devices 108 are possible for surfaces equipped with an ice removal system as illustrated in FIG. 1A. One such system 240 is illustrated in FIG. 2B, and another 260 in FIG. 2C, and another 280 in FIG. 2D.

In the embodiment 240 of FIG. 2B, a coil 242 has a surrounding core 244 that does not provide a complete magnetic loop for flux generated by the coil 242. A rod 246 of ferromagnetic material is arranged such that it may be drawn into a space within an axis of coil 242 when coil 242 is energized, rod 246 is attached through a pad 248 to the surface 104; in this embodiment coil 242, core 244, and rod 246 together form actuation device 108. As previously described, surface 104 has an insulating or dielectric layer 110 and a resistive layer 112. In this embodiment, a pulse of current applied to coil 242 will draw rod 246 into a center of coil 242, thereby deflecting surface 104 towards support 106 to crack and draw air under ice (not shown).

In the embodiment 260 of FIG. 2C, a coil 262 is also provided with a surrounding core 264 that does not provide a complete magnetic loop for flux generated by the coil 262. A rod 266 of ferromagnetic material is arranged such that it may be drawn into a space within an axis of coil 262 when coil 262 is energized, rod 266 is attached through a nonmagnetic pushrod 268 and a force-dispersion pad 270 to the surface 104; in this embodiment coil 262, core 264, rod 266 and pushrod 268 together form actuation device 108. In this embodiment, a pulse of current applied to coil 262 will draw rod 266 into a center of coil 262, thereby deflecting surface 104 away from support 106 to crack and draw air under ice (not shown) and thereby ejecting ice from the surface. The actuation devices of FIGS. 2C and 2B can be described as incorporating a solenoid coupled to deflect or deform the surface.

In the embodiment 280 of FIG. 2D, an electric or pneumatic motor 282 is provided. A cam 284 is rotated by motor 282. A cam-follower-pushrod 286 is attached to the surface 104, and may be provided with suitable cam-follower guides; in this embodiment motor 282, cam 284, and cam-follower-pushrod 286 together form actuation device 108. In this embodiment, current applied to motor 282 will spin cam 284 thereby causing cam follower 286 to bump against cam 284. As cam follower 286 bumps cam 284, cam follower 286 is deflected thereby deflecting surface 104 away from support 106 to crack and draw air under ice (not shown) thereby ejecting ice from the surface. In a similar embodiment, motor 282 drives a crank having an connecting-arm-pushrod attached to it on an eccentric, instead of a cam; as motor 282 spins, surface 104 is vibrated through the connecting-arm-pushrod.

An embodiment 300 having two superimposed coils 302, 304 is illustrated in FIG. 3. One of these coils, coil 304, is attached to a rigid support 306. The other coil, mobile coil 302, is attached to a flexible dielectric layer 308. The flexible dielectric layer 308 is coated with, or laminated to, an electrically resistive, conductive, layer 310. Resistive layer 310 may have an additional dielectric coating, not shown. Ice 312 forms adherent to resistive layer 310, or to the additional dielectric coating on resistive layer 310.

In operation, pulse electrothermal power supply 314 applies a pulse of electrical current to resistive layer 310 to melt an interfacial layer of ice 312 adjacent to resistive layer 310. Only an interfacial layer is melted; the bulk of ice 312 remains frozen at a temperature below the freezing point of the ice. This portion of the method is substantially identical to that previously discussed with reference to the embodiment of FIGS. 1 and 2.

Unlike the system of Giamati, deflection serves to release ice where an interfacial layer has already been melted by heat from the resistive layer. At least a portion of the resistive layer therefore overlies the coils as illustrated, instead of Giamati's configuration where his resistive layer is on “the apex” distant from his coils.

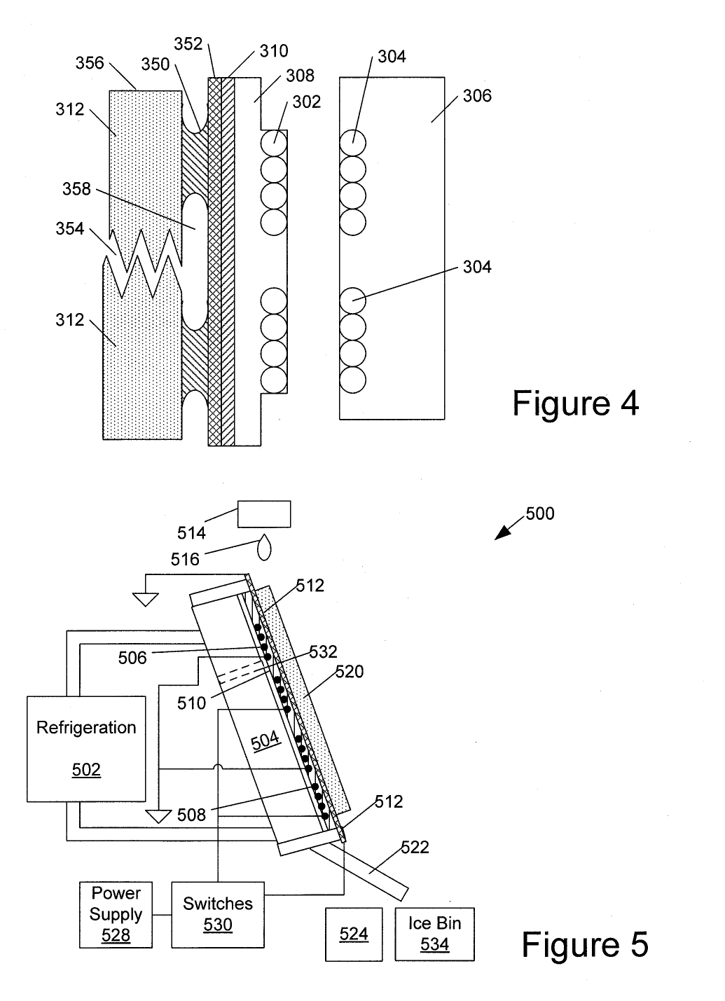

Once the interfacial layer of ice has been melted, actuation power supply 316 applies a pulse of electrical current to the actuation device comprising both coils 302, 304. Each coil 302, 304 develops a magnetic field, and the two magnetic fields interact causing movement of the mobile coil 302, thereby deflecting flexible dielectric 308 and resistive layer 310, to apply stresses to the meltwater 350 of the softened interfacial layer (FIG. 4) at the boundary between still-frozen portions of ice 312 and resistive layer 310 or a dielectric coating 352 on resistive layer 310. In a particular embodiment, initial deflection of mobile coil 302 is away from coil 304 and propelling ice 312 away from support 306, however in alternative embodiments, initial deflection of mobile coil 302 may be towards coil 304.

After a brief time, an electronic switching device 318 of actuation power supply 316 reverses current in one coil of coils 302, 304. This current reversal reverses polarity of the magnetic field produced by that coil, thereby reversing the deflection of mobile coil 302. In the embodiment where initial deflection of mobile coil 302 is away from coil 304, current reversal causes deflection of mobile coil 302 towards coil 304 and thereby drawing resistive layer 310 away from now-moving ice 312. By drawing resistive layer 310 away from ice 312, the system encourages entry of air through cracks 354 in ice 312 and at edges 356 of ice 312 into a space 358, initially narrow and filled with meltwater 350 derived from the melted interfacial layer, between ice 312 and resistive layer 310. Entry of air into the space between ice 312 and resistive layer 310 widens the space 358 and permits separation of ice 312 from the surface. Multiple current reversals may be used such that the surface is vibrated.

The electrothermal power supply 314 and the actuation power supply 316 are controlled and powered by a deicing power source and sequence controller 330.

In an embodiment of the system of FIG. 3, as illustrated in FIG. 7, the electrothermal pulse has a duration less than one hundred milliseconds, and the actuation pulse of about 6 kHz alternating-current power has a duration of approximately two milliseconds in the first polarity and six hundred microseconds with the current reversed in one coil.

The present ice-removal system is adaptable to the leading edges of aircraft wings. Multiple actuation devices 108 may be distributed over a surface of the wing, and the resistive layer 112 may be divided into zones each having one or more actuation device 108, here each zone has separate electrical connections to the resistive layer 112 and actuation devices 108 or coils 140, and each zone may be activated by coupling to power supplies 120, 122 individually. When deicing of a zone is desired the resistive layer of that zone is coupled to power from electrothermal power supply 120, when the boundary layer is melted the actuation device(s) 108 or coil(s) 140 of that zone are coupled to power from actuation power supply 122 to remove the ice. In such an embodiment, multiple coils of the type illustrated in FIG. 1C, or multiple coil pairs of the type illustrated in FIG. 3, may be distributed over the surface to be deiced, such as the leading edge of a wing.

In an ice-flake maker 500 embodying the present invention, as illustrated in FIG. 5, a conventional refrigeration system 502 circulates cooled refrigerant through passages in a cold-plate 504, which is fabricated from a thermally and electrically conductive material, such as aluminum.

First and second coils 506, 508 are embedded in a dielectric membrane 510, the membrane is attached to edges of, and when coils 506, 508 are not active lies on, a surface of cold plate 504. On an ice-forming surface of membrane 510 is deposited a resistive layer 512. Water dispensing apparatus 514 as known in the art of icemakers is arranged to spray a mist of, or dribble water 516 onto, resistive layer 512, which may be made of stainless steel. As water 516 freezes into ice 520, any excess water 516 drops through a grate 522 into water trough 524, where portions of water 516 may be recycled to dispensing apparatus 514, or dumped into a sewer when excessive salts accumulate, as known in the icemaking machine art.

When ice 520 has accumulated to a desired thickness, power supply 528 is connected by switches 530 to provide power through resistive layer 512, thereby heating resistive layer and an interfacial layer of ice 520. After period of time from a few milliseconds to a few tens of milliseconds, switches 530 are reconfigured to apply power from power supply 528 to coils 506, 508 to cause a deflection of membrane 510 and resistive layer 512, thereby deflecting ice 520 from resistive layer 512. The power to coils 506, 508 is then turned off allowing membrane 510 and resistive layer 512 to retract into position, pulling away from ice 520 and furthering release of ice 520. The released ice 520 falls onto grate 522 and slides into an ice bin 534.

In an embodiment, cold-plate 504 has several air passages 532 that allow air movement on the reverse side of membrane 510.

To prevent accumulation of frost on parts of an icemaker that are cooled but not deiced, such parts can be coated with a thermally-insulating material.

While the icemaker of FIG. 5 has been described with reference to an actuation device formed by a coil 506, 508, interacting with an electrically conductive cold plate 504, it is anticipated that alternative embodiments of the icemaker may utilize any of the actuator devices heretofore discussed with reference to FIG. 1A, 1C, 1E, 2C, 2D, or 3 as an alternative actuation device. For conciseness, detailed description of these actuation devices with reference to the icemaker will be omitted. In an embodiment of the icemaker, power supply 528 may incorporate one or more charged capacitors for energy accumulation and storage, and switching devices to provide intense pulses by coupling the capacitors in parallel with the actuation device or resistive layer. In an embodiment, the resonant frequency of coils of the actuation device and the capacitor is in the range from 5 kHz to about 50 kHz; in a particular embodiment the resonant frequency is in the range from 5 kHz to 9 kHz to prevent undesirable radio frequency emissions.

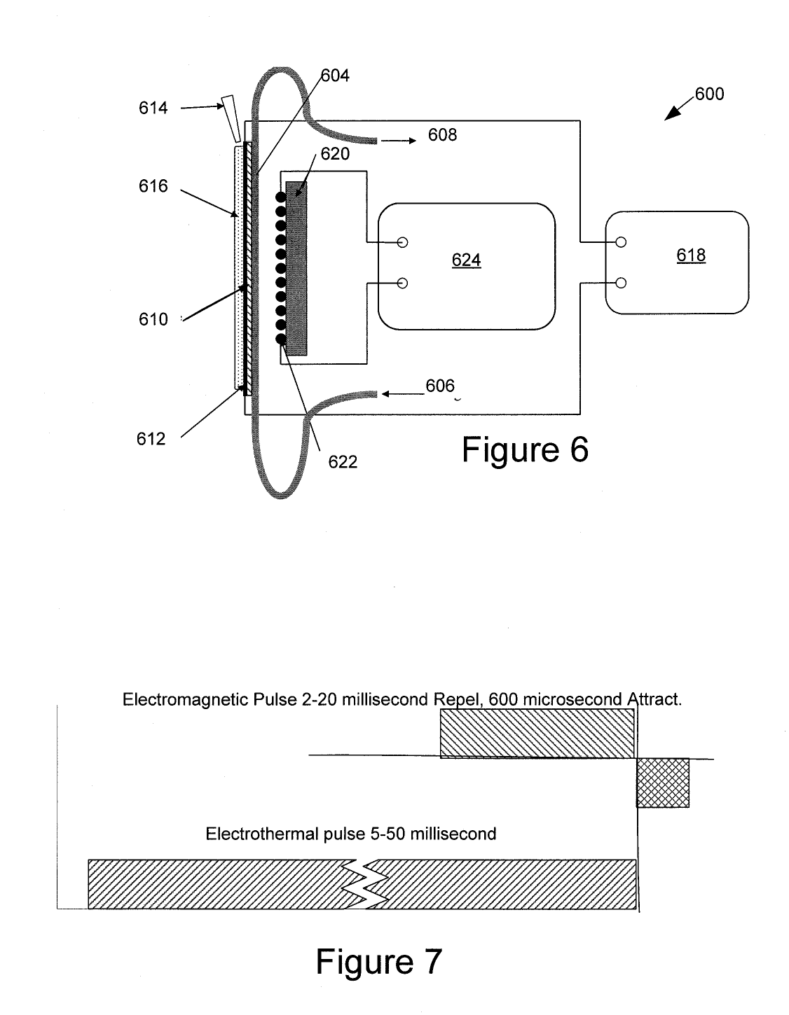

An alternative embodiment 600 of the icemaker (FIG. 6) has a thin, electrically conductive, microchannel cold plate 604 through which refrigerant flows, entering through a first flexible connection 606 and leaving through another flexible connection 608. Microchannel cold plate 604 has a dielectric coating 610, topped with an electrically resistive layer 612, which may have a further dielectric coating (not shown). Apparatus 614 for dispensing water is provided to drizzle or spray water onto the resistive layer 612 or its dielectric coating, whereupon the water freezes into ice 616. Resistance layer 612 is coupled to be powered by an electrothermal pulse power supply 618. In this embodiment of the present invention, microchannel cold plate 604 is shown by way of example and is representative of a fin or tube or similar element of an evaporator component of a refrigeration subsystem. The refrigeration subsystem may be of the type incorporating a volatile refrigerant circulating through a system having a compressor, a condenser, an orifice, and an evaporator comprising one or more “cold plate”-type elements having passages for refrigerant and which may have fins, tubes, or equivalents thereof. In this embodiment, the electrothermal pulse delivered through a resistive layer of the “cold plate”-type element serves to loosen ice by melting a boundary layer of the ice that may be adhering to the evaporator, while the actuation device causes sufficient mechanical disturbance in the evaporator to shake the loosened ice from the evaporator surfaces, thereby providing very significant time and energy savings over an electrothermal-only type deicing system used in the same application. It should be understood by those skilled in the art that various exemplary embodiments of the inventive deicing apparatus may be readily configured, and/or adapted, for use with a wide range of refrigerant evaporator components to provide improved deicing capabilities thereto without departing from the spirit of the present invention. Such enhanced evaporator components incorporating the inventive deicing system may be readily utilized in virtually any application in which evaporators are typically used, such as in icemakers, refrigeration solutions, HVAC applications, etc.

A rigid nonconductive support 620, made for example from fiberglass, is firmly attached to a frame (not shown) of the icemaker. Attached to this support is a coil 622. Coil 622 is coupled to be powered by an actuation pulse power supply 624.

Operation of the embodiment of FIG. 6 is similar to that of the embodiment of FIG. 5. Chilled refrigerant circulates in the cold plate 604, while water is drizzled on resistive layer 612 (or its dielectric coating) to form ice 616. Once ice has accumulated to a desired thickness, a short pulse of power is provided by electrothermal pulse power supply 618 to the resistive layer 612, causing sufficient heating to melt a thin interfacial layer of the ice 616 at the ice-resistance layer 612 boundary. In an embodiment, this pulse lasts substantially less than a second. As the electrothermal pulse ends, or a few hundred microseconds before it ends, power is applied by actuation power supply 624 to coil 622, thereby sharply deflecting the sandwich of cold plate 604, dielectric 610, and resistive layer 612; the combination of melting the interfacial layer of ice with the mechanical disturbance of the sandwich detaches ice 616.

Alternative embodiments of the ice-flake maker and icemaker of FIGS. 5 and 6 incorporate the motor-cam follower arrangement of FIG. 2D, or the solenoid-pushrod arrangement of FIG. 2C, as actuation devices for vibrating membrane 510 or microchannel cold plate 604 to release ice after a boundary layer of the ice has been melted by the electrothermal pulse applied to resistive layer 512. In these embodiments the actuation pulse applied to the motor is typically longer than pulses applied to the flat coil arrangement of FIG. 5 to provide multiple rotations of the cam or crank-wheel.

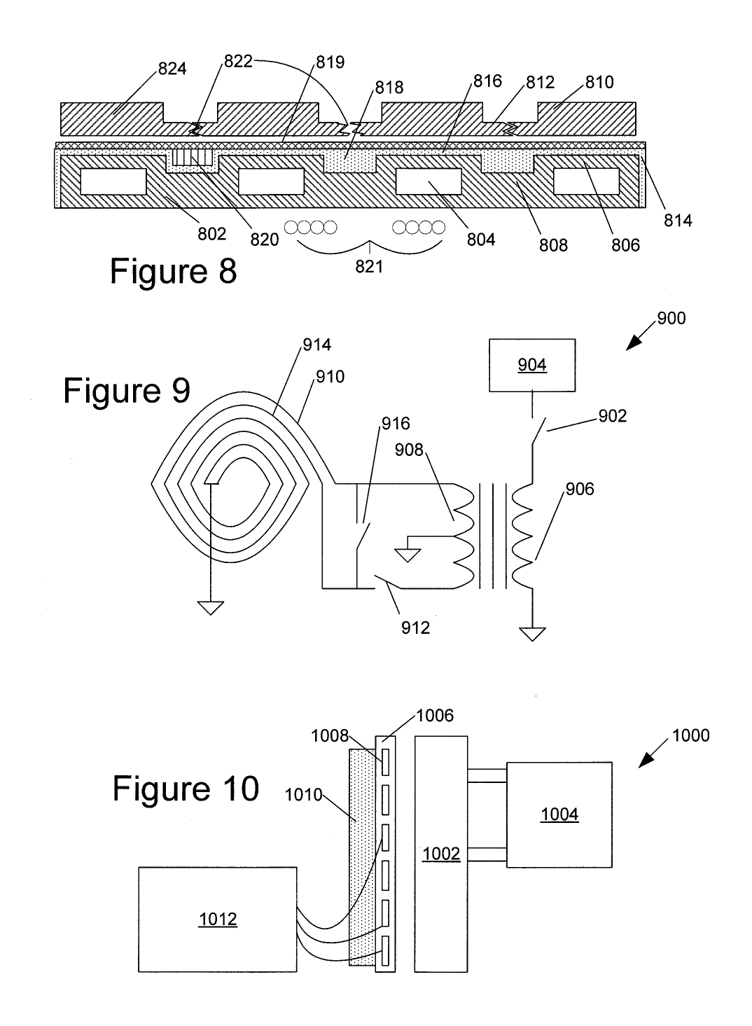

Embodiments such as the icemakers of FIGS. 5 and 6 may use variations in thickness of the dielectric layers between cold plate, conductive sheet, and resistive layer to produce variations in thickness of ice formed thereon; these variations may define individual ice bodies, such as ice flakes or ice cubes, or may score the ice such that it breaks into bodies of preferred sizes when it is detached and falls into the bin. For example, FIG. 8 illustrates a variation of the icemaker of FIG. 6 including electrically conductive cold plate 802 having microchannels 804 for refrigerant flow. Cold plate 802 has high portions 806 over which thick 810 ice forms, and low portions 808 where thin 812 ice forms. In this embodiment, dielectric layer 814 has thin portions 816 overlying high portions 806 of cold plate 802, and thick portions 818 overlying low portions 808 of cold plate 802. In embodiments where dielectric layer 814 is formed by anodizing an aluminum surface of cold plate 802, thick portions may be formed by applying a coating of an additional dielectric material 820 where thin 812 ice is desired. Atop the dielectric layer is resistive layer 819. Ice release occurs with a sequence of an electrothermal pulse applied to resistive layer 819 followed by an actuation pulse applied to a coil 821 attached to a solid substrate (not shown). When deflection of cold plate 802 caused by the actuation pulse completes releasing ice from this system, thin 812 ice is weaker than thick 810 ice, hence there is a tendency for fractures 822 to form in thin 812 ice, thereby breaking the ice into individual ice bodies 824.

In an embodiment of the icemakers of FIGS. 5 and 6, the electrothermal pulse typically has duration of less than one half second, and the actuation pulse a duration of less than about twenty milliseconds. In this embodiment, the actuation pulse is a high frequency alternating current such that a skin depth of induced current in the cold plate is substantially less than a thickness of the cold plate.

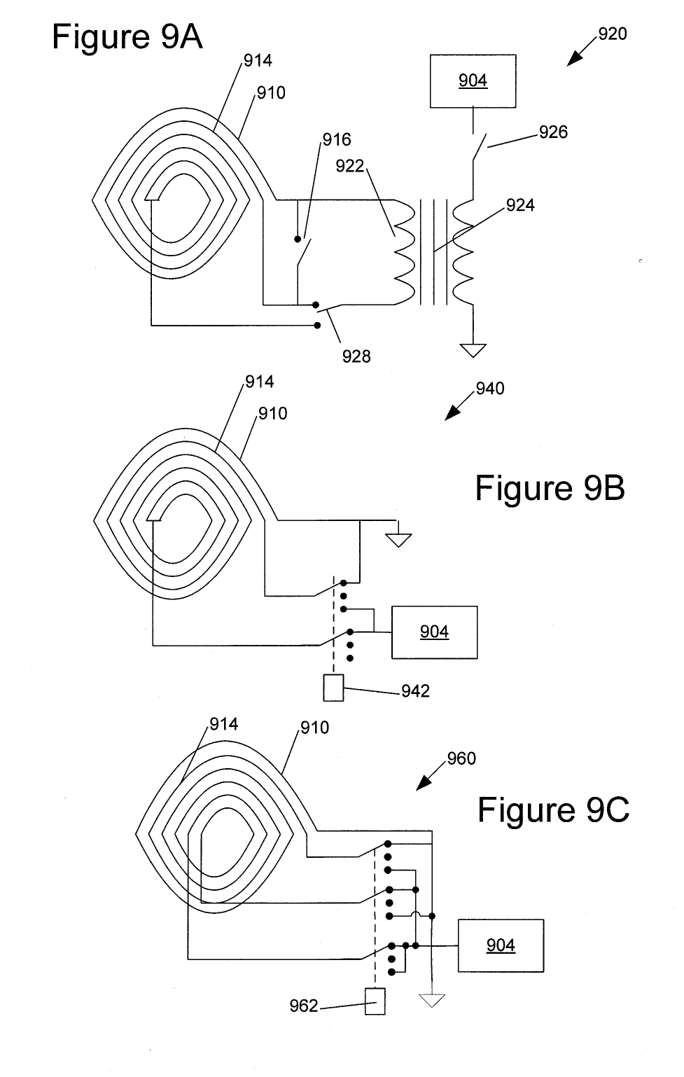

An electrical schematic is illustrated in FIG. 9 of an embodiment 900 in which the functions of electrothermal pulse heating and electromechanical ice release are combined in a single conductive coil layer. This conductive coil layer is embedded in a flexible membrane adjacent to a conductive metal plate as illustrated in FIG. 10 discussed below, or may be adjacent to a second, stationary, coil energized only during the actuation phase in an embodiment resembling that of FIG. 4. In this embodiment 900, a first switching device 902 applies a high frequency alternating current source 904 to a primary 906 of a transformer for the duration of both the electrothermal and actuation phases of ice release. A first phase center-tapped secondary 908 of the transformer is coupled to a first winding 910 of a coil, while a second phase of center-tapped secondary 908 is coupled through an electronic switching device 912 to a second winding 914 of the coil during the electrothermal phase only; leaving the second winding 914 de-energized during the actuation phase. The first 910 and second 914 windings of the coil are wound in a bifilar manner, such that magnetic fields generated cancel during the electrothermal phase, and, since second winding 914 is de-energized during the actuation phase, these fields fail to cancel during the actuation phase, thereby generating a magnetic field and deflecting the surface to assist with the ice removal. In the electrothermal phase, current in the first 910 and second 914 windings is sufficiently high, and the coil has sufficient electrical resistance, that heat is produced in the coils 910, 914 sufficiently to melt an interfacial layer of any ice adherent to the membrane. In the actuation phase, the deflection produced by the uncancelled magnetic field produced by the coil interacting with magnetic fields produced by currents induced in a nearby conductive plate deflect the membrane enough to release the ice.

In an alternative embodiment of this design, an additional electronic switch 916 is provided such that second winding 914 conducts current in the same direction as first winding 910 in the actuation phase, with the currents in the same direction the magnetic fields of these two coils add and thereby create a strong magnetic field for distorting the surface to assist with the ice removal. In alternatives to these embodiments, other switch configurations may be used to achieve similar results.

In an alternative embodiment 920 (FIG. 9A), the transformer 924 has an untapped secondary 922; transformer 924 is typically a step-down transformer to provide high currents to coils 910, 914. First switching device 926 operates as described above to apply power to the transformer for the duration of ice removal, causing current to flow in a first direction through coil 910. Second double-throw electronic switching device 928 applies current in series in forward direction to coil 910 and reverse direction to coil 914 during the heating phase, this reverse direction current in coil 914 is disconnected and switch 928 applies current in forward direction to coil 910 and, through third switching device 916, in forward direction to coil 914 during the actuation phase. The net effect is that magnetic fields in coil 914 are cancelled during heating phase, and additive during actuation phase.

In another alternative embodiment 940 (FIG. 9B), no transformer is provided. Double-pole, triple-throw, electronic switching device 942 applies current in series in forward direction to coil 910 and reverse direction to coil 914 during the heating phase, this reverse direction current in coil 914 is disconnected and switch 942 applies current in forward direction to coil 910 and in forward direction to coil 914 during the actuation phase. Electronic switching device 942 has a third mode wherein no current flows in the coils.

In another alternative embodiment 960 (FIG. 9C), no transformer is provided. Triple-pole, triple-throw, electronic switching device 962 applies current in parallel in forward direction to coil 910 and reverse direction to coil 914 during the heating phase, this reverse direction current in coil 914 is disconnected and switch 942 applies current in forward direction to coil 910 and in forward direction to coil 914 during the actuation phase. Electronic switching device 942 has a third setting wherein no current flows in the coils.

In the embodiments of FIGS. 9, 9A, 9B, and 9C, power supply 904 may operate in some embodiments at a single voltage for both the electrothermal and electromechanical actuation phases. In alternative embodiments, power supply 904 may be a DC-AC converter that provides a first voltage during the electrothermal phase and a second voltage during the actuation phase.

A portion 1000 of an icemaker resembling that of FIG. 5 is illustrated in FIG. 10. In this embodiment, a stationary cold plate 1002 is cooled by conventional refrigeration apparatus 1004. Lying on cold plate 1002 is a composite membrane 1006 constructed of a high-strength filler such as fiberglass, carbon fiber, or an aramid fiber with a plastic resin binder. Embedded within composite membrane 1006 is a bifilar coil 1008 of a conductive material such as copper, aluminum, or nickel-chromium alloy foil. Ice 1010 forms on membrane 1006. When it is desired to release ice 1010, power supply, controller, and switching apparatus 1012 applies an electrothermal pulse of alternating current to a first, and in a reverse phase to a second, winding of bifilar-wound coil 1008. When sufficient heat has been generated in coil 1008 to begin melting the ice-membrane interface, either the current in the second winding of bifilar-wound coil 1008 is disconnected, or the current in second winding of bifilar-wound coil 1008 is reversed. This change in current in the second winding of bifilar-wound coil 1008 results in un-cancelled magnetic fields inducing current in conductive cold plate 1002 and therefore a deflection of membrane 1006 sufficient to release ice 1010.

The ice removal apparatus herein described is applicable to icemakers having an ice-forming surface formed into a mold. In embodiments having a mold, in addition to the resistive layer and coils for deflecting the mold surface similar to that herein described, additional apparatus as known in the art of icemakers is provided for tipping the mold such that released ice may fall into the bin.

In embodiments such as the icemakers of FIGS. 5 and 6, it is desirable to use short, high intensity, pulses from the electrothermal power supply to melt the interfacial layer. Since heat from the resistive layer takes time to propagate into the ice and into the cold plates, short intense pulses permit application of sufficient energy to melt a thin layer of ice at the interface without substantially warming either the cold plates or the bulk of the ice.

Since the bulk of the ice can remain significantly below the freezing point of its constituent water, and only a thin layer of meltwater is produced, meltwater on the detached ice can refreeze as the ice falls into the storage bin thereby reducing the tendency of ice fragments or flakes in the bin to stick to each other. Similarly, since energy is required to melt ice, less energy is required to produce a thin layer of meltwater at the interface than is required to produce the thicker layer of meltwater at the interface required in machines not capable of applying mechanical deflection to the interface.

The present combined electromechanical and electrothermal pulse ice-detachment technique also offers icemakers the ability to make thinner flakes of ice than using purely electrothermal ice release because thin flakes of ice do not have sufficient weight for gravity alone to overcome surface tension of the interfacial layer meltwater.

In order to reduce ice accumulation on cold icemaker components (such as refrigerant flexible connections 606, 608) that are not themselves regularly deiced with combined electrothermal and actuation pulses, these components are typically coated with layers of thermal insulation.

The ice removal apparatus disclosed herein is configured to provide sequences of pulse pairs, each pulse pair having an electrothermal pulse to the resistive layers, with an actuation pulse to the coils commencing typically after the start of the electrothermal pulse. The actuation pulses are typically timed to provide maximum mechanical stress to the ice-surface interface at the time of maximum melting of the interfacial layer caused by the electrothermal pulses. The ice removal apparatus disclosed herein typically does not prevent ice from forming, but is typically controlled by a controller such that pulse sequences are provided to release ice when ice has accumulated to a predetermined thickness.

For those skilled in the art it is apparent that the deicing apparatus described above can also be used to deice surfaces of airplanes, including leading edges of aircraft wings, bridges, roads, airport runways, building roofs, and blades of rotors of windmills. The term windmill is used herein to include vertical and horizontal wind turbines as known in the art.

The embodiments illustrated and described above were shown either with two coils or a coil and a conductive plate that are parallel and centered above each other to generate electromotive forces normal to the ice-surface interface. In alternative embodiments, the conductive plate may be mounted at an angle to the coil, or a first coil may be deliberately misaligned with a second coil in a dual-coil embodiment, to generate electromotive forces at an angle to the surface.

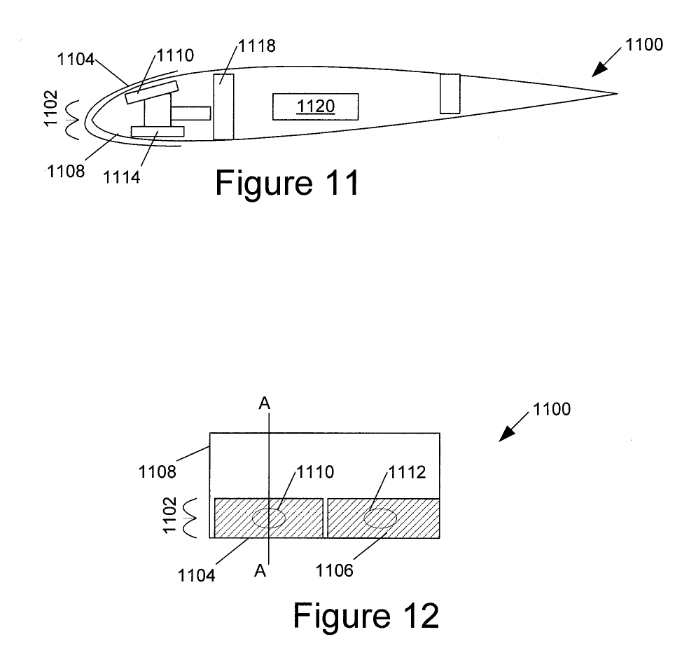

In an embodiment 1100 fitted to an aerodynamic surface, as illustrated in FIGS. 11 and 12, such as an aircraft wing, propeller or helicopter rotor blade, or a windmill blade, it is known that ice tends to accumulate preferentially on leading edges 1102 and may often reach thicknesses that can interfere with airflow and may imbalance the blade or wing. FIG. 11 represents a cross section of the aerodynamic surface of FIG. 12 taken as A-A. It is also known that much less ice tends to accumulate on surfaces significantly behind the leading edge 1102, it is therefore particularly necessary to prevent excess accumulation on leading edges of these surfaces.

In the embodiment 1100 of FIGS. 11 and 12, the system may be divided into separately-energized zones. For example, a resistive layer may be separated into a first zone 1104 resistive layer, and a second zone resistive layer 1106. Resistive layer 1104, 1106 is applied over a dielectric layer (not shown) over a conductive skin 1108 such as 2024 sheet aluminum. Beneath the conductive skin is mounted a first zone 1110 and a second zone 1112 coil. Coils 1110, 1112 may be paired with opposing coils 1114 on an opposite side of the aerodynamic surface, and are secured with vibration isolation to structure, such as forward spar 1118 of the surface. In this embodiment, resistive layer 1104 typically covers coil 1110.

In operation of the embodiment 1100 of FIGS. 11 and 12, ice is allowed to accumulate to a thickness preferred for release. An electrothermal pulse is then applied to the resistive layer 1104 of the first zone by power supply and controller apparatus 1120, followed by an electromagnetic actuation pulse to the coils 1110, 1114 of the first zone, to release the ice therefrom. This pulse sequence is then followed by a pulse sequence to the resistive layer 1106 and coils 1112 of the second zone to release ice therefrom.

Each actuation pulse provided by the actuation power supplies to the actuation devices of various embodiments described herein may be one, or a burst of multiple, direct current pulses, may be a burst of alternating current, or may be a combination thereof, as required for the specific actuation devices to provide sufficient mechanical disturbance of the surface to release the ice. Similarly, each electrothermal pulse may be one, or a burst of multiple, direct current pulses, may be a burst of alternating current, or may be a combination thereof.

While the invention has been particularly shown and described with reference to a preferred embodiment thereof, it will be understood by those skilled in the art that various other changes in the form and details may be made without departing from the spirit and scope of the invention. It is to be understood that various changes may be made in adapting the invention to different embodiments without departing from the broader inventive concepts disclosed herein and comprehended by the claims that follow.

What is claimed is:

1. An apparatus for removing ice from a surface, the surface having an electrically resistive layer for heating at least a heated portion of the surface, the apparatus comprising:
an actuation device apparatus coupled to deflect at least the heated portion of the surface upon receiving electric power;
power supply apparatus coupled to provide power to the resistive layer thereby heating the resistive layer, and to provide power to the actuation apparatus, wherein the power supply apparatus is configured to provide a first pulse to the resistive layer to generate heat and to provide a second pulse to the actuation apparatus during a deice cycle, and wherein the first, and second pulses have a time relationship such that a peak tension induced by the second pulse on an interface between the ice and the surface occurs after a portion of ice at the interface is melted by the generated heat.

2. The apparatus of claim 1 further comprising a sensor for determining a measurement of thickness of ice on the surface, wherein the power supply apparatus comprises a controller, and wherein the controller determines a magnitude of the second pulse based upon the measurement of thickness of the ice.

3. The apparatus of claim 2 wherein the controller determines the time relationship between the first and the second pulse based upon the measurement of thickness of the ice.

4. The apparatus for removing ice from a surface of claim 1, wherein the actuation device apparatus comprises:
a conductive layer of the surface, and
a coil attached disposed adjacent to the conductive layer of the surface and attached to a support.

5. The apparatus for removing ice from a surface of claim 1, wherein the actuation device apparatus comprises a magnetic layer attached to the surface and an electromagnet.

6. The apparatus for removing ice from a surface of claim 1, wherein the actuation device apparatus comprises a solenoid coupled to deflect the surface.

7. The apparatus of claim 1 wherein surface is a surface of an airplane, such as an including leading edges of a wings, a surface of a bridge or roads, an airport runway, a building roofs, and a blades of a rotors of a windmill.

8. An apparatus for removing ice from a surface, the surface having a resistive layer, and a dielectric layer, the apparatus comprising:
a coil attached to the dielectric layer of the surface and disposed adjacent to a conductive sheet attached to a support; and
power supply apparatus coupled to provide power to the resistive layer, and to the coil, wherein the power supply apparatus is configured to provide a first pulse to the resistive layer and to provide a second pulse to the coil;
and wherein the resistive layer has at least a portion overlying the coil
and a pulse-sequence controller for controlling the power supply apparatus, and for coordinating timing of the first pulse and the second pulse.

9. An apparatus for removing ice from a surface, the surface having a resistive layer, and a dielectric layer, the apparatus comprising:
a first coil attached to the dielectric layer;
a second coil attached disposed adjacent to the first coil and attached to a support;
power supply apparatus coupled to provide power to the resistive layer, and to the first and second coils, wherein the power supply apparatus is configured to provide a first pulse to the resistive layer, to provide a second pulse to the first coil, and a third pulse to the second coil; and
a sequence controller for coordinating the first, second, and third pulses such that peak tension induced by the second and third pulses on an interface between ice and a component of the surface occurs after a portion of the interface is melted by the first pulse.

10. The apparatus for removing ice of claim 9, wherein a polarity of a pulse selected from the group consisting of the second and third pulses is reversed relative to the other member of the group consisting of the second and third pulses at a point in time after the beginning of the second and third pulses.

11. An icemaker comprising:
an ice-forming surface having a resistive layer formed on a dielectric layer;
a cold plate disposed to remove heat from the ice-forming surface such that water on the ice-forming surface solidifies into ice;
a support, the cold plate disposed between the surface and the support;
an actuation device coupled to deflect the surface away from the cold plate upon application of electric power to the actuation device;
water dispensing apparatus for applying water to the ice-forming surface;
power supply apparatus configured for providing a first pulse of power to the resistive layer, and a second pulse of power to the actuation device, the first pulse for melting an interfacial layer of the ice, the second pulse for deflecting the ice-forming surface.

12. The icemaker of claim 11 wherein the actuation device comprises a first coil disposed between the cold plate and the surface, wherein the cold plate is constructed of an electrical conductor, and wherein the cold plate is electrically conductive, and deflecting of the surface is produced from an interaction of a magnetic field produced by the first coil when driven by the second pulse, and a magnetic field produced by induced currents in the cold plate.

13. The icemaker of claim 11, wherein the actuation device comprises a first coil and a second coil disposed between the cold plate and the surface and wherein the power supply apparatus is configured to provide power to the second coil simultaneously with the second pulse, and wherein deflecting of the surface is produced from an interaction of a magnetic field produced by the first coil with a magnetic field produced by the second coil.

14. The icemaker of claim 11 wherein the power supply apparatus is configured to provide the first pulse with duration of less than one half second, and the second pulse with duration of less than twenty milliseconds.

15. The icemaker of claim 11 wherein a dielectric layer disposed between the resistive layer and the cold plate has a first thickness for forming thick ice, and a second thickness for forming thin ice.

16. The icemaker of claim 11 wherein a thermally-insulating layer is applied to cold parts of the icemaker that are not regularly deiced by the actuation device and resistive layer

17. An aerodynamic structure selected from the group consisting of a wing and a windmill blade, the aerodynamic structure having a leading edge zone comprising:
a surface sheet;
a dielectric layer applied over the surface sheet;
a resistive layer applied over the dielectric layer;
an actuation device disposed to deflect the surface sheet; and
a power supply and controller apparatus;
wherein the power supply and controller apparatus are coupled to provide an electrothermal pulse to the resistive layer, and an actuation pulse to the actuation device in a deice cycle, the deice cycle being less than ten seconds.

18. The aerodynamic structure of claim 17 wherein the actuation device comprises at least a first coil disposed beneath the surface sheet, wherein the surface sheet is electrically conductive, and the actuation device deflects the surface sheet through interaction of a magnetic field from the coil with a magnetic field from a current induced in the surface sheet.

19. The structure of claim 17 wherein the structure is a windmill blade.

20. A surface and apparatus for removing ice from the surface, the surface comprising:
a first and second coil embedded within a dielectric membrane, the first and second coil bifilar wound; and
a conductive layer disposed near the dielectric membrane;
the apparatus comprising:
power supply apparatus coupled to provide alternating current power to the first coil, and to the second coil;
wherein the power supply apparatus is configured to provide a first pulse to the first coil simultaneously with a first pulse to the second coil, the first pulse to the second coil having direction such that magnetic fields produced by the second coil cancel magnetic fields produced by the first pulse in the first coil, the first pulse providing heat; and
wherein the power supply apparatus is configured to provide a second pulse to the first coil wherein magnetic fields produced by the second pulse in the first coil are not cancelled by current in the second coil, such that magnetic fields produced by the second pulse in the first coil may induce a current in the conductive layer thereby generating magnetic fields that deflect the membrane.

21. The surface and apparatus of claim 20 wherein the power supply apparatus is configured to provide a second pulse to the second coil simultaneously with the second pulse in the first coil, the second pulse in the second coil in a direction such that magnetic fields produced by the second pulse in the second coil add to those produced by the second pulse in the first coil.

22. An icemaker embodying the surface and apparatus of claim 20, and further comprising apparatus for applying water to the surface and refrigeration apparatus such that the water freezes into ice on the surface, and a bin for collecting ice released from the surface.

23. A system of the type comprising a refrigerant circulating through a compressor, a condenser, an orifice, and an evaporator, wherein the improvement comprises deicing apparatus adapted to remove ice from the evaporator comprising:
an electrically resistive layer of the evaporator;
an electrothermal power supply adapted to provide an electrothermal pulse of sufficient electrical current to the resistive layer to melt a boundary layer of ice adherent to the evaporator;
an electrically-powered actuation device for vibrating the evaporator to remove ice therefrom;
an actuation power supply for providing a electrical actuation power pulse to the actuation device; and
a timing device for directing the electrothermal power supply to provide an electrothermal pulse, and for directing the actuation power supply to provide an actuation power pulse, to deice the evaporator.

24. The system of claim 23 wherein the evaporator comprises a cold plate of an icemaker.
